(19) United States
(12) Patent Application Publication
(10) Pub. No.: US 2024/0385358 A1
(43) Pub. Date: Nov. 21, 2024

(54) PROJECTION ASSEMBLY COMPRISING A COMPOSITE PANE

(71) Applicant: SAINT-GOBAIN GLASS FRANCE, COURBEVOIE (FR)

(72) Inventors: Jan HAGEN, HERZOGENRATH (DE); Valentin SCHULZ, HERZOGENRATH (DE); Martin ARNDT, HERZOGENRATH (DE); Pauline GIRARD, HERZOGENRATH (DE)

(21) Appl. No.: 18/696,190

(22) PCT Filed: Sep. 7, 2022
(86) PCT No.: PCT/EP2022/074862

§ 371 Date: Mar. 27, 2024

(30) Foreign Application Priority Data
Sep. 28, 2021 (EP) 21199333.2

(51) Int. Cl. G02B 5/30; G02B 27/01; G02B 27/09

(52) U.S. Cl. CPC G02B 5/3041; G02B 27/0101; G02B 27/0983; G02B 2027/013

(57) ABSTRACT

A laminated pane includes an outer and an inner pane each having an outer-side surface and an interior-side surface and a thermoplastic intermediate layer. The interior-side surface of the outer pane and the outer-side surface of the inner pane are connected to one another via the thermoplastic intermediate layer, a reflective layer is arranged in at least a first sub-region of the laminated pane on the interior-side surface of the inner pane directly adjacent to the surroundings, which reflective layer is configured to reflect p-polarized light of a light source, an opaque cover layer is arranged at least in a second sub-region of the laminated pane. Starting from the interior-side surface, the reflective layer includes an optically high refractive index layer with a refractive index of greater than or equal to 1.7 and an optically low refractive index layer with a refractive index of less than or equal to 1.6.

The invention relates to a projection arrangement, a method for the production thereof, and the use thereof.

In the automotive sector, windshields with functional elements are increasingly used. They include, for example, display elements which enable use of the glazing as a display, wherein transparency of the glazing is preserved. With such displays, the driver of a motor vehicle can have relevant information displayed directly in the windshield of the motor vehicle without having to divert attention from the road. Applications in buses, trains or other public transport means in which current information on the course of the journey or advertising are projected onto the glazing are also known.

In order to display navigation information in windshields, projection arrangements known under the term of head-up displays (HUD) consisting of a projector and windshield with a wedge-angle thermoplastic intermediate layer and/or with wedge-angle panes are often used. A wedge angle is necessary to avoid double images. The projected image appears in the form of a virtual image at a certain distance from the windshield so that the driver of the motor vehicle sees, for example, the projected navigation information as being in front of him on the road. DE 102009020824 A1 describes a virtual image system comprising a windshield and an image source, wherein the real rays of the image source impinge on the windshield, are reflected there as virtual rays, and broken rays of the real image rays impinge on a matte black material on the windshield surfaces in order to prevent ghost images. Typically, the radiation from HUD projectors is substantially s-polarized due to the better reflection characteristics of the windshield compared to p-polarization. However, if the viewer wears polarization-selective sunglasses which transmit only p-polarized light, the HUD image will be perceived attenuated at best. A solution to this problem is the use of projection arrangements that employ p-polarized light. DE102014220189A1 discloses a head-up display projection arrangement which is operated with p-polarized radiation, wherein the windshield has a reflective structure which reflects p-polarized radiation in the direction of the viewer. US20040135742A1 also discloses a head-up display projection arrangement using p-polarized radiation which has a reflective structure. WO 96/19347A3 proposes a multi-layer polymer layer as a reflective structure. WO 2021145387 A1 discloses a vehicle pane with an HUD coating comprising high refractive index layers and low refractive index layers.

Another known concept for depicting information on a pane is the integration of display films which are based on a diffuse reflection. They generate a real image which, for the viewer, appears in the plane of the glazing. Glazings with transparent display films are known, for example, from EP 2 670 594 A1 and EP 2 856 256 A1. The diffuse reflection of the display element is produced by means of a rough internal surface and a coating located thereon. EP 3 151 062 A1 describes a projection arrangement for integration in an automobile glazing.

The windshield of a motor vehicle can thus simultaneously be used as a projection surface for a virtual HUD image and a real image based on diffuse reflection. These different projection technologies are also used to move displays such as the speed display, warnings or vehicle data which are conventionally integrated in the dashboard of a vehicle, into the windshield. However, a plurality of large-area projections on the windshield can be irritating to the driver. Furthermore, the projectors used for head-up displays must have a correspondingly large output in order to ensure that the projected image has sufficient brightness even when backlit and can be clearly seen by the viewer. Such projectors have a comparatively high energy consumption.

Accordingly, there is a need for projection arrangements which have a good contrast of the generated image even when backlit and a low energy consumption and can be operated with p-polarized light. The object of the present invention is to provide such an improved laminated pane, a method for the production thereof and a use thereof.

According to the invention, this object is achieved by a projection arrangement according to claim 1. Preferred embodiments result from the dependent claims.

The projection arrangement according to the invention comprises a laminated pane and a light source for p-polarized light. The laminated pane comprises an outer pane with an outer-side surface (side I) and an interior-side surface (side II), an inner pane with an outer-side surface (side III) and an interior-side surface (side IV) and a thermoplastic intermediate layer which connects the interior-side surface of the outer pane to the outer-side surface of the inner pane. The laminated pane has at least one first sub-region in which a reflective layer is arranged on the interior-side surface of the inner pane. The reflective layer is arranged on the interior-side surface of the inner pane such that it forms an exposed surface of the laminated pane, i.e., a surface directly adjoining the surroundings. In other words, the reflective layer forms the layer furthest away from the thermoplastic intermediate layer in the direction of the inner pane. Starting from the interior-side surface of the inner pane, the reflective layer comprises at least one optically high refractive index layer with a refractive index of greater than or equal to 1.7 and an optically low refractive index layer with a refractive index of less than or equal to 1.6, arranged in this order and flat one above the other. The laminated pane furthermore has at least one opaque cover layer in at least in one second sub-region of the laminated pane, which is arranged on the outer-side surface of the outer pane, on the interior-side surface of the outer pane, on the outer-side surface of the inner pane and/or on the interior-side surface of the inner pane. The opaque cover layer can be arranged indirectly or directly on the pane surface. At least one opaque cover layer is arranged in a region of the pane in which the reflective layer also lies so that an overlapping region of reflective layer and opaque layer exists. Thus, when the second sub-region with the opaque cover layer is projected into the plane of the first sub-region in which the reflective layer lies, an at least partial congruence of the two sub-regions results. In the installed state of the projection arrangement in a vehicle, the reflective layer has a smaller distance from the vehicle interior than the opaque cover layer. The light source for p-polarized light is arranged on the side of the interior-side surface of the inner pane and is thus located in the vehicle interior when the projection arrangement is installed in a vehicle. Accordingly, light of the light source emanating from the vehicle interior impinges on the reflective layer of the laminated pane and is reflected there. The reflected light can be seen as an image by a viewer located in the vehicle interior. The opaque cover layer lies behind the reflective layer as viewed by the viewer in the vehicle interior so that a transmission of light from the surroundings into the interior of the vehicle is avoided in the region of the reflective layer. As a result, the image in the region of the reflective layer has good contrast. The inventors have found that a reflective layer comprising a high refractive index layer and a low refractive index layer is particularly suitable as regards high reflectivity for p-polarized light. In comparison, a single low refractive index layer or a single high refractive index layer has a significantly lower reflectivity. In particular the combination of the reflective layer according to the invention and the opaque cover layer therebehind, from the perspective of a vehicle passenger, causes good visibility of the image, even in external sunlight, for occupants with sunglasses, and when using faint light sources. Even under these circumstances, the image generated by the light source appears bright and can be seen perfectly. This enables a reduction in the power of the light source and thus a reduced energy consumption.

From the viewpoint of a vehicle occupant, the reflective layer is arranged spatially in front of the opaque cover layer in the view through the inner pane. As a result, the region of the laminated pane in which the reflective layer is arranged appears opaque. The reflective layer in front of the opaque background is preferably transparent, but can also be opaque itself. The expression “when looking through the laminated pane” means looking through the laminated pane starting from the interior-side surface of the inner pane. The expression “spatially in front of,” as used in the present invention, means that the reflective layer is arranged spatially further away from the outer-side surface of the outer pane than at least the opaque cover layer. The opaque cover layer can be applied to one or more pane surfaces. An advantage of the invention in this regard is that the reflective layer is suitable for being applied freely exposed to the interior-side surface of the inner pane. The surface on which the opaque cover layer is to be placed can thus be freely selected according to customer wishes. In contrast, a reflective layer applied on the outer-side surface of the inner pane or the interior-side surface of the outer pane could be covered by a cover print located further in the direction of the vehicle interior. This is avoided by means of the layout according to the invention. If the opaque cover layer is arranged on the interior-side surface of the inner pane, the reflective layer is applied on the surface of the opaque cover layer facing away from the inner pane and is thus not impaired in its function by the cover layer. The reflective layer can be applied indirectly or directly, preferably directly, to the opaque cover layer. Preferably, the opaque cover layer is widened at least in the region which overlaps with the reflective layer and in which the laminated pane is used for displaying images. This means that when viewed perpendicular to the closest section of the circumferential edge of the laminated pane, the opaque cover layer has a greater width than in other sections. In this way, the opaque cover layer can be adapted to the dimensions of the reflective layer. The opaque cover layer is preferably formed circumferentially along the circumferential edge of the laminated pane in the edge region of the laminated pane, wherein the width of the cover layer varies.

Within the meaning of the invention, an exposed surface is understood to mean a surface that is accessible and has direct contact with the surrounding atmosphere. It may also be referred to as an external surface. An exposed surface is to be distinguished from internal surfaces of a laminated pane which are connected to one another via the thermoplastic intermediate layer. If the pane is designed as a laminated pane, the outer-side surface of the outer pane and the interior-side surface of the inner pane (i.e., of the substrate according to the invention) are exposed.

The term “flatly arranged on top of one another” is understood to mean that the projection of a first layer into the plane of a second layer is at least partially congruent with the second layer.

The laminated pane is preferably a vehicle windshield.

The at least one opaque cover layer within the meaning of the invention is a layer that prevents the view through the laminated pane. In this case, at most 5%, preferably at most 2%, particularly preferably at most 1%, in particular at most 0.1%, of the light of the visible spectrum is transmitted through the opaque cover layer.

The light source of the projection arrangement emits p-polarized light, and is arranged in the vicinity of the interior-side surface of the inner pane such that the light source irradiates this surface, wherein the light is reflected by the reflective layer of the laminated pane. The reflective layer preferably reflects at least 5%, preferably at least 6%, particularly preferably at least 10%, of the p-polarized light impinging on the reflective layer in a wavelength range of 450 nm to 650 nm and angles of incidence of 55° to 75°. This is advantageous in order to achieve the highest possible brightness of an image emitted by the light source and reflected on the reflective layer.

The light source serves to emit an image, and can thus also be referred to as a display device or image display device. A projector, a display, or a different device known to the person skilled in the art can be used as the light source. The light source is preferably a display, particularly preferably an LCD display, LED display, OLED display, or electroluminescent display, in particular an LCD display. Displays have a low installation height and are thus simply integrated into the dashboard of a vehicle in a space-saving manner. Moreover, displays can be operated in a significantly more energy-saving manner in comparison to projectors. The comparatively lower brightness of displays is completely sufficient in combination with the reflective layer according to the invention and the opaque cover layer behind it. The radiation of the light source preferably impinges in the region of the reflective layer at an incidence angle of 55° to 80° on the laminated pane, preferably of 62° to 77° on the laminated pane. The incidence angle is the angle between the incidence vector of the radiation of the image display device and the surface normal in the geometric center of the reflective layer.

The term “p-polarized light” means light of the visible spectrum that predominantly has p-polarization. The p-polarized light preferably has a light portion with p-polarization of at least 50%, preferably of at least 70%, particularly preferably of at least 90%, and in particular of approximately 100%. The polarization direction is viewed in relation to the plane of incidence of the radiation on the laminated pane. P-polarized radiation refers to a radiation the electric field of which oscillates in the plane of incidence. S-polarized radiation refers to a radiation the electric field of which oscillates perpendicular to the plane of incidence. The plane of incidence is spanned by the incident vector and the surface normal of the laminated pane in the geometric center of the irradiated region. In other words, the polarization, i.e., in particular, the proportion of p-polarized and s-polarized radiation, is determined at a point of the region irradiated by the light source-preferably in the geometric center of the irradiated region. Since laminated panes can be curved (for example, when configured as a windshield), which has effects upon the plane of incidence of the radiation, polarization components slightly deviating therefrom can occur in the other regions, which is unavoidable for physical reasons.

Preferably, at least one opaque cover layer is arranged in an edge region of the outer pane. Such an opaque cover layer preferably serves to mask a bonding of the laminated pane, e.g., as a windshield, into a vehicle body. This gives a harmonic overall impression of the laminated pane in the installed state. Furthermore, the opaque cover print serves as UV protection for the adhesive material used.

An opaque cover layer located on the outer pane is preferably printed onto the outer pane, in particular by screen printing. Screen printing methods for applying opaque cover layers to panes are known as such. Such printed cover layers are also referred to as screen print or black print and contain an opaque pigment, for example a black pigment. Known black pigments are, for example, carbon black, aniline black, leg black, iron oxide black, spinel black, and graphite. An opaque cover layer printed with the screen printing method is preferably subjected to a temperature treatment in order to permanently connect it to the glass surface. The temperature treatment is typically carried out at temperatures in the range of 450° C. to 700° C. If the outer pane is bent, thermal treatment of a screen print to be applied thereto can also take place while bending the pane.

The opaque cover layer on the outer pane can be applied on the interior-side surface of the outer pane and/or to the outer-side surface of the outer pane. In this case, the interior surface of the outer pane is preferred in that the opaque cover print is protected from weather effects. Particularly preferably, at least one opaque cover layer in the form of an opaque cover print is arranged on the interior-side surface of the outer pane and/or the interior-side surface of the inner pane. An opaque cover print applied to the inner-side surface of the inner pane also conceals the view from the vehicle interior through the laminated pane to the outside. For example, components, such as electrical connections, laminated into the laminated pane can be concealed. Also, customers wish to be able to freely select the position of the cover print and, if necessary, to also be able to apply it to the interior-side surface of the inner pane. In contrast to layers which are suitable only for internal use in the laminated pane, the reflective layer arranged directly adjacent to the surroundings on the interior-side surface of the inner pane enables a combination with cover layers on the interior-side surface of the inner pane. In contrast, a reflective layer applied internally, i.e., on side II or side III, would be covered by a cover layer applied on side IV.

The reflective layer is applied on a sub-region of the interior-side surface of the inner pane. The reflective layer is preferably in direct contact with the interior-side surface of the inner pane (side IV) or an opaque cover layer applied on this pane surface. The reflective layer is arranged at least in one region on side IV of the laminated pane, which region is overlaps with the opaque cover layer when looking through the laminated pane. This means that the p-polarized light projected onto the reflective layer by the light source impinges on the laminated pane in the region in which the opaque cover layer is located. A high contrast of the display is thereby achieved.

In this order, starting from the interior-side surface of the inner pane, the reflective layer comprises at least one optically high refractive index layer and one optically low refractive index layer. This means that at least one optically low refractive index layer is arranged at a greater distance from the interior-side surface of the inner pane than an optically high refractive index layer. Conversely, at least one optically high refractive index layer is arranged at a lower distance from the interior-side surface of the inner pane than an optically low refractive index layer. The layers of the reflective layer are arranged flat one above the other on the interior-side surface of the inner pane.

Preferably, the high refractive index layer has a refractive index of at least 1.8, particularly preferably at least 1.9, and very particularly preferably at least 2.0. The increase in the refractive index results in a highly-refractive effect. The high refractive index layer can also be referred to as a reflection-increasing layer, since it typically increases the overall reflectivity of the coated surface. The mentioned refractive indices lead to particularly good results. The refractive index is preferably at most 2.5—a further increase in the refractive index would not result in any further improvement as regards the p-polarized radiation, but would increase overall reflectivity.

In the context of the present invention, refractive indices are in all cases specified in relation to a wavelength of 550 nm. Methods for determining refractive indices are known to the person skilled in the art. The refractive indices specified within the scope of the invention can be determined, for example, by ellipsometry, wherein commercially available ellipsometers can be used. Unless otherwise indicated, the specification of layer thicknesses or thicknesses refers to the geometric thickness of a layer.

Suitable materials for the high refractive index layer are silicon nitride (Si₃N₄), a silicon-metal mixed nitride (for example, silicon zirconium nitride (SiZrN), silicon-aluminum mixed nitride, silicon-hafnium mixed nitride, or silicon-titanium mixed nitride), aluminum nitride, tin oxide, niobium oxide, bismuth oxide, titanium oxide, tin-zinc mixed oxide, and zirconium oxide. Furthermore, transition metal oxides (such as scandium oxide, yttrium oxide, tantalum oxide) or lanthanide oxides (such as lanthanum oxide or cerium oxide) can also be used. The high refractive index layer preferably contains one or more of these materials or is formed on the basis thereof.

The high refractive index layer can be applied by physical or chemical vapor deposition, i.e., a PVD or CVD method (PVD: physical vapor deposition, CVD: chemical vapor deposition). Suitable materials, on the basis of which the coating is preferably formed, are, in particular, silicon nitride, a silicon-metal mixed nitride (for example, silicon zirconium nitride, silicon-aluminum mixed nitride, silicon-hafnium mixed nitride, or silicon-titanium mixed nitride), aluminum nitride, tin oxide, niobium oxide, bismuth oxide, titanium oxide, zirconium oxide, or tin-zinc mixed oxide. Preferably, the high refractive index layer is a coating applied by cathode sputtering, and in particular a coating applied by magnetic field-assisted cathode sputtering (“magnetron sputtering”).

Particularly preferably, the high refractive index layer is a sol-gel coating. Advantages of the sol-gel method as a wet-chemical method are a high flexibility which, for example, allows only parts of the pane surface to be provided in an easy manner with the coating, and low costs compared to vapor depositions such as cathode sputtering. The high refractive index layer applied as a sol-gel coating preferably contains titanium oxide or zirconium oxide, particularly preferably titanium oxide, in order to achieve the refractive index according to the invention. Layers comprising titanium dioxide which are deposited by means of PVD methods are subject to greater crystallinity changes during thermal treatment of the pane. A high refractive index layer applied as a sol-gel coating comprising titanium oxide is at least partially amorphous and does not have this disadvantage. The chemical conversion of the sol-gel is helpful in avoiding problems during temperature treatments.

In the sol-gel method, a sol which contains the precursors of the coating is first provided and matured. Maturing may include hydrolysis of the precursors and/or a (partial) reaction between the precursors. The precursors are usually present in a solvent-preferably water, alcohol (in particular, ethanol), or a water-alcohol mixture.

In one embodiment, the sol-gel coating is formed on the basis of titanium oxide or zirconium oxide. The sol contains titanium oxide or zirconium oxide precursors.

The sol is applied to the interior-side surface of the inner pane indirectly or directly, in particular by wet chemical methods, for example by dip coating, spin coating, flow coating, by application by means of rollers or brushes, or by spray coating, or by printing methods, for example by pad printing or screen printing. Drying can then take place, whereby solvent is evaporated. This drying can take place at ambient temperature or by separate heating (for example at a temperature of up to 120° C.). Before the layer is applied to the substrate, the surface is typically cleaned by methods known per se.

The sol is then condensed. Condensation can comprise a heat treatment which can be carried out as a separate heat treatment at, for example, up to 500° C. or in the context of a glass bending process, typically at temperatures of 600° C. to 700° C. If the precursors have UV-crosslinkable functional groups (for example a methacrylate, vinyl, or acrylate group), condensation can comprise a UV treatment. Alternatively, with suitable precursors (for example, silicates), the condensation can comprise an IR treatment. Optionally, solvent can be evaporated, for example at a temperature of up to 120° C.

In a preferred embodiment, the refractive index of the optically low refractive index layer is at most 1.6, preferably at most 1.5, particularly preferably at most 1.4, for example 1.25 to 1.35. These values have proven to be particularly advantageous with regard to the reflection properties of the pane.

The low refractive index layer is preferably formed on the basis of nanoporous silicon oxide. The reflection properties of the layer are determined, on the one hand, by the refractive index and, on the other hand, by the thickness of the low refractive index layer. The refractive index, in turn, depends on the pore size and the density of the pores. In a preferred embodiment, the pores are dimensioned and distributed such that the refractive index is from 1.2 to 1.4, particularly preferably from 1.25 to 1.35. A refractive index in these ranges is particularly advantageous to achieve a homogeneous reflection spectrum in the angle of incidence range around 65° and around 75°. The thickness of the low refractive index layer is preferably from 30 nm to 500 nm, particularly preferably from 50 nm to 150 nm. Good properties are thus achieved.

The silicon oxide can be doped, for example with aluminum, zirconium, titanium, boron, tin, or zinc. In particular the optical, mechanical and chemical properties of the coating can be adapted by dopants.

The low refractive index layer preferably comprises only one homogeneous layer of nanoporous silicon oxide. However, it is also possible to form the low refractive index layer from a plurality of layers of nanoporous silicon oxide which differ, for example, in terms of porosity (size and/or density of the pores). A profile of refractive indices can thus be generated, so to speak.

The pores are in particular closed nanopores, but can also be open pores. Nanopores are understood to mean pores which have sizes in the nanometer range, i.e., from 1 nm to less than 1,000 nm (1 μm). The pores preferably have a substantially circular cross-section (spherical pores), but can also have other cross-sections, for example an elliptical, oval or elongated cross-section (ellipsoidal or ovoid pores). Preferably, at least 80% of all pores have substantially the same cross-sectional shape. It can be advantageous if the pore size is at least 20 nm or even at least 40 nm. The average size of the pores is preferably from 1 nm to 500 nm, particularly preferably from 1 nm to 100 nm, very particularly preferably from 20 nm to 80 nm. With circular pores, the size of the pore is understood to mean the diameter, and with pores of other shapes, the greatest linear expansion. Preferably, at least 80% of all pores have sizes in the specified ranges; particularly preferably, the sizes of all pores lie within the specified ranges. The proportion of pore volume in the total volume preferably lies between 10% and 90%, particularly preferably below 80%, and very particularly preferably below 60%.

The low refractive index layer is also preferably a sol-gel coating. It is deposited on the high refractive index layer in a sol-gel process. Firstly, a sol which contains the precursors for the coating is provided and matured. Maturing may include hydrolysis of the precursors and/or a (partial) reaction between the precursors. In the context of the invention, this sol is referred to as precursor sol and contains silicon oxide precursors in a solvent. The precursors are preferably silanes, and in particular tetraethoxy silanes or methyltriethoxysilane (MTEOS). Alternatively, however, it is also possible to use silicates as precursors-in particular, sodium, lithium, or potassium silicates, e.g., tetramethyl orthosilicate, tetraethyl orthosilicate (TEOS), tetraisopropyl orthosilicate, or organosilanes of the general form R²ₙSi(OR¹)₄₋ₙ. Preferably, R¹ is an alkyl group, R² is an alkyl, epoxy, acrylate, methacrylate, amine, phenyl, or vinyl group, and n is an integer from 0 to 2. It is also possible to use silicon halides or alkoxides. The solvent is preferably water, alcohol (in particular, ethanol), or a water-alcohol mixture.

The precursor sol is then mixed with a pore former which is dispersed in an aqueous phase. The task of the pore former is to generate the pores in the silicon oxide matrix more or less as a placeholder during the creation of the low refractive index layer. The shape, size and density of the pores are determined by shape, size and concentration of the pore former. The pore former can specifically control pore size, pore distribution, and pore density, and reproducible results are ensured. For example, polymer nanoparticles can be used as pore formers, preferably PMMA (polymethyl methacrylate) nanoparticles, but alternatively also nanoparticles made of polycarbonates, polyesters, or polystyrenes, or copolymers made of methyl (meth) acrylates and (meth) acrylic acid. Nanodrops of an oil in the form of a nanoemulsion can also be used instead of polymer nanoparticles. Of course, it is also conceivable to use different pore formers.

The solution obtained in this manner is applied to the high refractive index layer on the interior-side surface of the inner pane. This is expediently carried out by wet-chemical methods, for example by means of those mentioned for the deposition of the high refractive index layer.

The sol is then condensed. The silicon oxide matrix forms around the pore formers. Condensation can comprise a temperature treatment, for example at a temperature of up to 350° C., for example. If the precursors have UV-crosslinkable functional groups (for example a methacrylate, vinyl, or acrylate group), condensation can comprise a UV treatment. Alternatively, with suitable precursors (for example, silicates), the condensation can comprise an IR treatment. Optionally, solvent can be evaporated at a temperature of up to 120° C., for example.

The pore former is then optionally removed. For this purpose, the coated substrate is preferably subjected to a heat treatment at a temperature of at least 400° C., preferably at least 500° C., wherein the pore formers decompose. Organic pore formers are in particular carbonized. The heat treatment can take place within the scope of a bending process or thermal prestressing process. The heat treatment is preferably carried out over a period of at most 15 min., particularly preferably at most 5 min. In addition to removing the pore formers, heat treatment can also serve to complete the condensation and to thereby compress the coating, which improves its mechanical properties, in particular its stability.

Instead of using heat treatment, the pore former can also be dissolved out of the coating by solvents. In case of polymer nanoparticles, the corresponding polymer must be soluble in the solvent; for example, tetrahydrofuran (THF) can be used in case of PMMA nanoparticles.

Removal of the pore former is preferred, whereby empty pores are produced. In principle, it is also possible, however, to leave the pore former in the pores. The refractive index is influenced if the pore former has a different refractive index than the silicon oxide. The pores are then filled with the pore former, for example with PMMA nanoparticles. Hollow particles can also be used as pore formers, for example hollow polymer nanoparticles such as PMMA nanoparticles or hollow silicon oxide nanoparticles. If such a pore former is left in the pores and not removed, the pores will have a hollow core and an edge region filled with the pore former.

The described sol-gel method allows the production of a low refractive index layer with a regular, homogeneous distribution of the pores. The pore shape, size and density can be set in a targeted manner, and the low refractive index layer has a low tortuosity.

The reflective layer comprises at least one high refractive index layer and at least one low refractive index layer. Accordingly, a plurality of high refractive index layers and low refractive index layers can also be applied, wherein these are preferably applied alternately to one another. In the case of an alternating layer sequence, the layers bordering a low refractive index layer are high refractive index layers, and those bordering a high refractive index layer are low refractive index layers. Viewed starting from the inner pane, the layer stack of high refractive index layers and low refractive index layers starts preferably with a high refractive index layer. In this case, the exposed surface of the reflective layer with which the layer stack ends can optionally be formed by a high refractive index layer or a low refractive index layer. In a preferred embodiment, the reflective layer comprises exactly one low refractive index layer and exactly one high refractive index layer, wherein the high refractive index layer has a smaller distance from the inner pane than the low refractive index layer. The high refractive index layer is thus the layer of the reflective coating closer to the inner pane, while the low refractive index layer ends the layer stack and is the surface of the reflective coating exposed to the surroundings. The low refractive index layer is thus arranged above the high refractive index layer, relative to the interior-side surface of the inner pane. The low refractive index layer is preferably deposited directly on the high refractive index layer, i.e., no further layers are arranged between the high refractive index layer and the low refractive index layer. Particularly preferably, the reflective coating consists of exactly one single high refractive index layer and exactly one single low refractive index layer and has no further layers below or above this layer. The inventors have found that surprisingly, a reflective coating comprising exactly one low refractive index layer and exactly one high refractive index layer has an improved reflection behavior for p-polarized light, wherein in particular less angle dependence is discernible.

Preferably, the high refractive index layers each have a layer thickness of 30 nm to 150 nm, particularly preferably of 30 nm to 100 nm, and in particular of 40 nm to 70 nm. Preferably, the low refractive index layer each have a thickness of 100 nm to 300 nm, particularly preferably of 150 nm to 250 nm, in particular of 165 nm to 220 nm. A particularly advantageous reflection of p-polarized light over a large angular range can be achieved within these layer thickness ranges. This applies, in particular, when the reflective coating comprises exactly one high refractive index layer and exactly one low refractive index layer, and when the layer thicknesses lie within the ranges mentioned in each case.

In order to achieve the most color-neutral representation of the image generated in the region of the reflective layer, the reflection spectrum should be as smooth as possible with respect to p-polarized radiation and should not have any prominent local minima and maxima. Preferably, in the spectral range from 450 nm to 650 nm, the difference between the maximum reflectance and the mean value of reflectance as well as the difference between the minimum reflectance and the mean value of reflectance should be at most 3%, particularly preferably at most 2%. The emitted difference is to be understood as an absolute deviation of the reflectance (indicated in %), and not as a percentage deviation relative to the mean value. Alternatively, the standard deviation in the spectral range of 450 nm to 650 nm can be used as a measure of the smoothness of the reflection spectrum. In this regard, a reflective layer comprising exactly one high refractive index layer and exactly one low refractive index layer has proven to be advantageous.

In a preferred embodiment of the invention, an HUD layer is arranged between the interior-side surface of the outer pane and the outer-side surface of the inner pane. The principle of a head-up display (HUD) and the technical terms used herein in the field of HUDs are generally known to a person skilled in the art. For a detailed description, reference is made to the dissertation “Simulationsbasierte Messtechnik zur Prüfung von Head-Up Displays” [Simulation-based measurement technique for testing head-up displays] by Alexander Neumann at the Institute for Informatics of the Technical University of Munich (Munich: University library of TU Munich, 2012), in particular Chapter 2, “Das Head-Up Display” [The Head-Up Display]. The HUD layer is arranged between the outer pane and the inner pane, wherein “between” can mean both within the thermoplastic intermediate layer and in direct spatial contact with the inner side of the outer pane and with the outer side of the inner pane. The HUD layer is suitably designed to reflect p-polarized light. The HUD layer is a reflective coating which is introduced over a large area in the laminated pane, wherein the region in which the HUD coating is located is also referred to as the HUD region. To use the laminated pane as a head-up display, a projector is directed onto the HUD region of the laminated pane. The radiation of the projector is preferably predominantly p-polarized. The HUD layer is suitable for reflecting p-polarized radiation. As a result, a virtual image is generated from the projector radiation which the driver of a vehicle can perceive behind the laminated pane.

The projection arrangement according to the invention is particularly suitable for combination with an HUD layer. The reflective layer provided on the interior-side surface of the inner pane and the opaque cover layer applied in this region are only locally limited to the edge region of the laminated pane and thus do not influence the HUD layer applied in the see-through region of the laminated pane. As a result of the reflective layer being positioned on an exposed surface of the laminated pane, the HUD layer can be applied independently of the latter to one of the internal surfaces of the laminated pane and is protected there from environmental influences.

The HUD layer preferably comprises at least one metal selected from the group consisting of aluminum, tin, titanium, copper, chromium, cobalt, iron, manganese, zirconium, cerium, yttrium, silver, gold, platinum, and palladium, or mixtures thereof.

In a preferred embodiment of the invention, the HUD layer is a coating containing a thin-film stack, i.e., a layer sequence of thin individual layers. This thin-film stack contains one or more electrically conductive layers on the basis of silver. The electrically conductive layer on the basis of silver gives the reflective coating the basic reflective properties and also an IR-reflecting effect and electrical conductivity. The electrically conductive layer is formed on the basis of silver. The conductive layer preferably contains at least 90 wt % silver, particularly preferably at least 99 wt % silver, and very particularly preferably at least 99.9 wt % silver. The silver layer can have dopings, e.g., palladium, gold, copper, or aluminum. Materials on the basis of silver are particularly suitable for reflecting p-polarized light. The use of silver has proven to be particularly advantageous in the reflection of p-polarized light. The coating has a thickness of 5 nm to 50 nm, and preferably of 8 nm to 25 nm.

If the HUD layer is designed as a coating, it is preferably applied to the inner pane or outer pane by physical vapor deposition (PVD), particularly preferably by cathode sputtering, and very particularly preferably by magnetic-field-assisted cathode sputtering (“magnetron sputtering”). In principle, however, the coating may also be applied, for example, by means of chemical vapor deposition (CVD), e.g., plasma-enhanced chemical vapor deposition (PECVD), by evaporation deposition, or by atomic layer deposition (ALD). The coating is applied to the panes before lamination.

The HUD layer may also be designed as a reflective film which reflects p-polarized light. The HUD layer may be a carrier film with a reflective coating, or a reflective polymer film. The reflective coating preferably comprises at least one layer on the basis of a metal and/or a dielectric layer sequence with alternating refractive indices. The layer on the basis of a metal preferably contains or consists of silver and/or aluminum. The dielectric layers can be formed, for example, on the basis of silicon nitride, zinc oxide, tin-zinc oxide, silicon-metal mixed nitrides, such as silicon-zirconium nitride, zirconium oxide, niobium oxide, hafnium oxide, tantalum oxide, or silicon carbide. The oxides and nitrides mentioned can be deposited stoichiometrically, substoichiometrically, or hyperstoichiometrically. They can have dopings, e.g., aluminum, zirconium, titanium, or boron. The reflective polymer film preferably comprises or consists of dielectric polymer layers. The dielectric polymer layers preferably contain PET. If the HUD layer is designed as a reflective film, it is preferably 30 μm to 300 μm, particularly preferably 50 μm to 200 μm, and in particular 100 μm to 150 μm, thick.

If the film is a coated, reflective film, the coating methods of CVD or PVD can likewise be used for the production.

According to a further preferred embodiment, the HUD layer is designed as a reflective film and is arranged within the thermoplastic intermediate layer. The advantage of this arrangement is that the HUD layer does not have to be applied to the outer pane or inner pane by means of thin film technology (e.g., CVD and PVD). This results in uses of the HUD layer with further advantageous functions, such as a more homogeneous reflection of the p-polarized light on the HUD layer. In addition, the production of the laminated pane can be simplified since the HUD layer does not have to be arranged on the outer or inner pane via an additional method before lamination.

The laminated pane of the projection arrangement is preferably a windshield. The optionally present HUD layer is located in the see-through region of the laminated pane. In one embodiment of the windshield for a motor vehicle, the total transmission through the laminated pane is at least 70% based on light type A. The term “total transmission” relates to the method defined by ECE-R 43, Annex 3, Section 9.1 for testing the light transmission of motor vehicle panes.

If a first layer is arranged above a second layer, this means, in the sense of the invention, that the first layer is arranged further away from the substrate on which the coating is applied than the second layer. If a first layer is arranged below a second layer, this means, in the sense of the invention, that the second layer is arranged further away from the substrate than the first layer.

If a layer is formed “on the basis of” a material, the layer consists predominantly of this material, in particular substantially of this material, in addition to any impurities or doping. The mentioned oxides and nitrides can be deposited stoichiometrically, hypostoichiometrically or hyperstoichiometrically (even if a stoichiometric total formula is indicated for better understanding). They can have dopings, e.g., aluminum, zirconium, titanium, or boron.

The outer pane and the inner pane preferably contain or consist of glass, particularly preferably flat glass, float glass, quartz glass, borosilicate glass, soda-lime glass, alumino silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can have further suitable coatings known per se, e.g., anti-reflective coatings, non-stick coatings, anti-scratch coatings, photocatalytic coatings or sun protection coatings, or low-e coatings.

The thickness of the individual panes (outer pane and inner pane) can vary widely and be adapted to the requirements of the individual case. Preferably, panes with the standard thicknesses of 0.5 mm to 5 mm and preferably of 1.0 mm to 2.5 mm are used. The size of the panes can vary widely and depends upon the use.

The laminated pane can have any three-dimensional shape. Preferably, the outer pane and the inner pane do not have any shadow zones, so that they can be coated, for example, by cathode sputtering. The outer pane and the inner pane are preferably flat or slightly or strongly curved in one direction or in several directions of the space.

The thermoplastic intermediate layer contains or consists of at least one thermoplastic polymer, preferably polyvinyl butyral (PVB), ethylene vinyl acetate (EVA), and/or polyurethane (PU), or copolymers or derivatives thereof, where applicable in combination with polyethylene terephthalate (PET). However, the thermoplastic intermediate layer may, for example, also contain polypropylene (PP), polyacrylate, polyethylene (PE), polycarbonate (PC), polymethyl methacrylate, polyvinyl chloride, polyacetate resin, casting resin, acrylate, fluorinated ethylene propylene, polyvinyl fluoride, and/or ethylene tetrafluoroethylene, or a copolymer or mixture thereof.

The thermoplastic intermediate layer is preferably designed as at least one thermoplastic composite film and contains or consists of polyvinyl butyral (PVB), particularly preferably of polyvinyl butyral (PVB), and additives, such as plasticizers, known to the person skilled in the art. The thermoplastic intermediate layer preferably contains at least one plasticizer.

Plasticizers are chemical compounds that make plastics softer, more flexible, smoother and/or more elastic. They shift the thermoelastic range of plastics to lower temperatures so that the plastics have the desired, more elastic properties in the range of the operating temperature. Preferred plasticizers are carboxylic esters, in particular low-volatile carboxylic esters, fats, oils, soft resins and camphor. Further plasticizers are preferably aliphatic diesters of tri- or tetraethylene glycols. Particular preferably used as plasticizers are 3G7, 3G8 or 4G7, wherein the first number denotes the number of ethylene glycol units and the last digit denotes the number of carbon atoms in the carboxylic acid portion of the compound. 3G8 thus stands for triethylene glycol bis(2-ethylhexanoate), i.e., for a compound of the formula C₄H₉CH (CH₂CH₃) CO (OCH₂CH₂)₃O₂CCH (CH₂CH₃) C₄H₉.

The thermoplastic intermediate layer on the basis of PVB preferably contains at least 3 wt %, preferably at least 5 wt %, particularly preferably at least 20 wt %, even more preferably at least 30 wt % and in particular at least 35 wt % of a plasticizer. The plasticizer contains or consists, for example, of triethylene glycol bis(2-ethylhexanoate).

The thermoplastic intermediate layer may be formed by a single film or also by more than one film. The thermoplastic intermediate layer may be formed by one or more thermoplastic films arranged one above the other, wherein the thickness of the thermoplastic intermediate layer is preferably 0.25 mm to 1 mm, typically 0.38 mm or 0.76 mm.

The thermoplastic intermediate layer may also be a functional thermoplastic intermediate layer, in particular an intermediate layer with acoustically damping properties, an intermediate layer reflecting infrared radiation, an intermediate layer absorbing infrared radiation, and/or an intermediate layer absorbing UV radiation. Thus, the thermoplastic intermediate layer may, for example, also be a band filter film that blocks out narrow bands of visible light.

Furthermore, the invention comprises a method for producing a projection arrangement according to the invention. The method comprises at least the steps of:
(a) providing an outer pane, an inner pane, and a thermoplastic intermediate layer,
(b) applying at least one opaque cover layer in at least one second sub-region of the outer-side surface of the outer pane, the interior-side surface of the outer pane, the outer-side surface of the inner pane, and/or on the outer-side surface of the inner pane,
(c) assembling the inner pane, the thermoplastic intermediate layer, and the outer pane in this order to form a layer stack,
(d) laminating the layer stack to form a laminated pane,
(e) applying a reflective layer on at least a first sub-region of the interior-side surface of the inner pane, wherein the first sub-region extends at least partially overlapping with the second sub-region, and wherein the applied reflective layer is located as an exposed layer on the interior-side surface of the inner pane,
(f) orienting a light source for p-polarized light onto the laminated pane so that the p-polarized light can impinge on the reflective layer.

Step e) of the method optionally takes place before, during, or after steps a) to d). However, if at least one opaque cover layer is applied on the interior-side surface of the inner pane, the reflective layer is applied only after the application of said opaque cover layer.

The reflective layer reflects the p-polarized light. The p-polarized light leaves the laminated pane on the inner side of the inner pane.

Lamination of the layer stack takes place under the action of heat, vacuum, and/or pressure, wherein the individual layers are bonded (laminated) by at least one thermoplastic intermediate layer. Methods known per se for producing a laminated pane can be used. For example, so-called autoclave processes can be carried out at an elevated pressure of about 10 bar to 15 bar and temperatures of 130° C. to 145° C. over about 2 hours. Vacuum bag or vacuum ring methods known per se operate, for example, at approximately 200 mbar and 130° C. to 145° C. The outer pane, the inner pane, and the thermoplastic intermediate layer may also be pressed in a calender between at least one roller pair to form a laminated pane. Systems of this type for the production of laminated panes are known and usually have at least one heating tunnel upstream of a pressing unit. The temperature during pressing is, for example, from 40° C. to 150° C. Combinations of calender and autoclave methods have proven particularly successful in practice. Vacuum laminators can be used as an alternative. They consist of one or more heatable and evacuable chambers in which the outer pane and the inner pane can be laminated within, for example, approximately 60 minutes at reduced pressures of 0.01 mbar to 800 mbar and temperatures of 80° C. to 170° C.

Methods for applying the reflective layer have already been explained in the description of the reflective layer itself.

In a preferred embodiment of the method, an HUD layer is applied on the interior-side surface of the inner pane and/or the outer-side surface of the inner pane before, during or after one of steps a) and b). In a further preferred embodiment, the HUD layer is a component of the thermoplastic intermediate layer and is introduced with the latter into the laminated pane. Methods for applying an HUD layer have already been explained in the description of the projection arrangement according to the invention.

The method features explained in the description of the projection arrangement according to the invention also apply to the method according to the invention.

The invention further extends to the use of the projection arrangement according to the invention in vehicles for traffic on land, in the air or on water, in particular in motor vehicles. The use of the laminated pane as a vehicle windshield is preferred.

The various embodiments of the invention may be implemented individually or in any combinations. In particular, the features mentioned above and to be explained below can be used not only in the specified combinations but also in other combinations or alone without departing from the scope of the present invention.

The invention is explained in more detail below with reference to exemplary embodiments, wherein reference is made to the accompanying figures. In a simplified, not-to-scale representation:

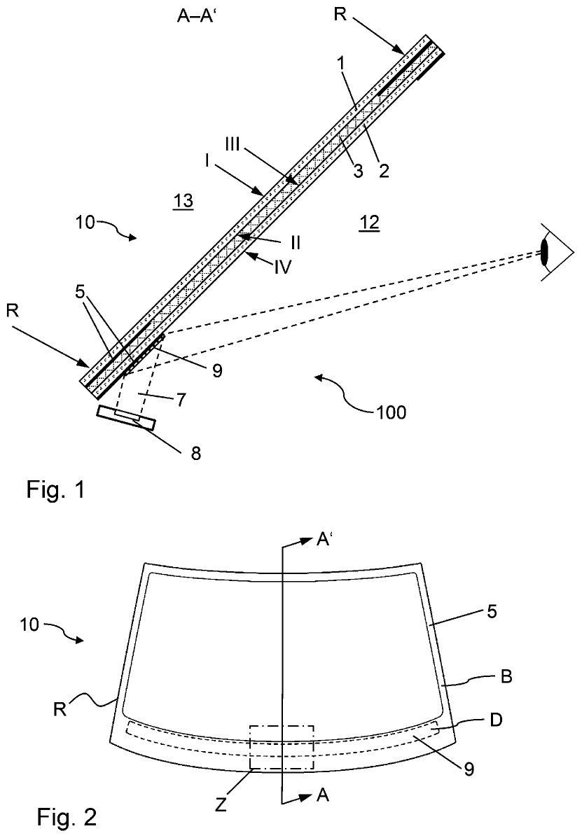

FIG. 1 shows a cross-sectional view of a preferred embodiment of the projection arrangement according to the invention,

FIG. 2 shows a plan view of the laminated pane of FIG. 1,

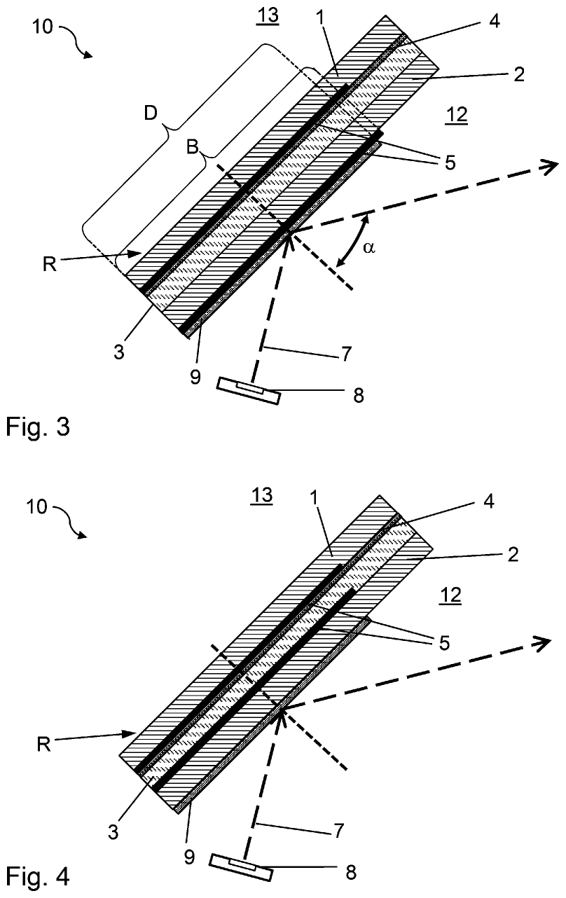

FIGS. 3-5 show different embodiments of the projection arrangement according to the invention in section Z along section line AA′ according to FIG. 2,

FIG. 6 shows a view of the inner pane of the laminated pane according to FIG. 1 with reflective coating in cross section along section line AA′;

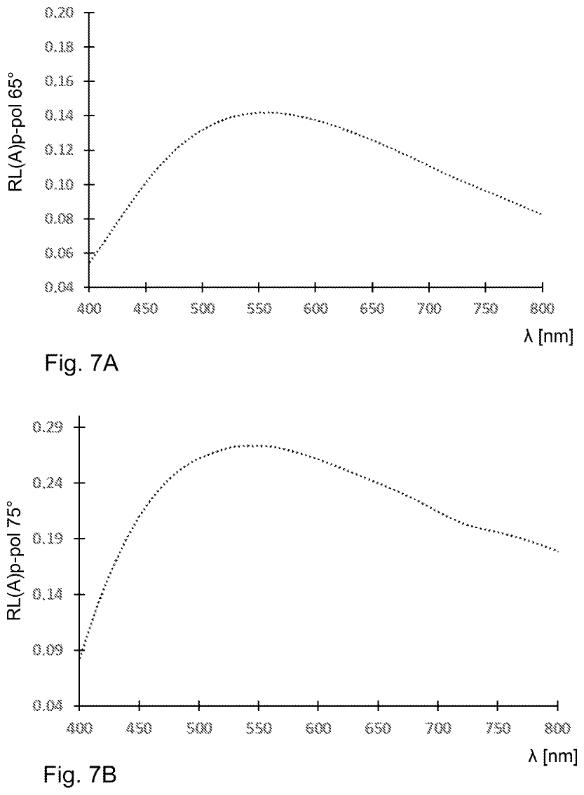

FIG. 7a shows a reflection spectrum of an inventive laminated pane according to Example 1 from Table 1 with respect to p-polarized radiation at 65°,

FIG. 7b shows a reflection spectrum of a laminated pane according to Example 1 from Table 1 with respect to p-polarized radiation at 75°,

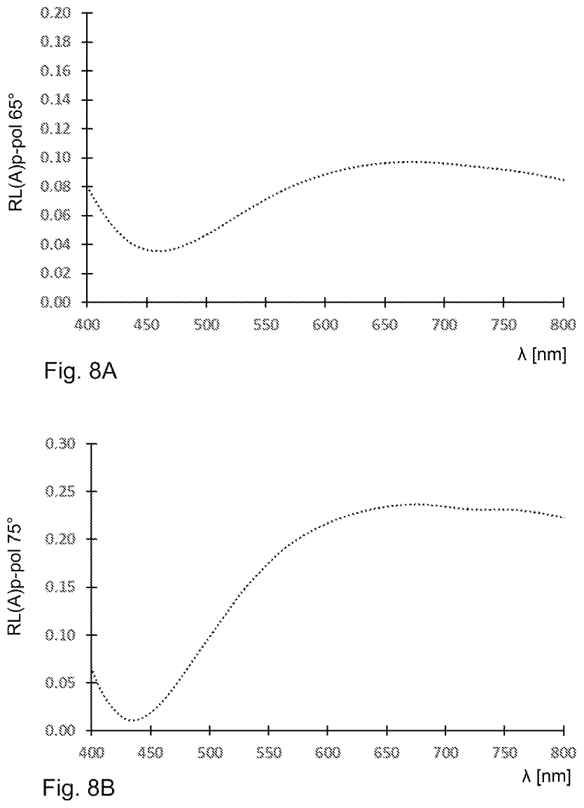

FIG. 8a shows a reflection spectrum of an inventive laminated pane according to Example 2 from Table 1 with respect to p-polarized radiation at 65°,

FIG. 8b shows a reflection spectrum of an inventive laminated pane according to Example 2 from Table 1 with respect to p-polarized radiation at 75°,

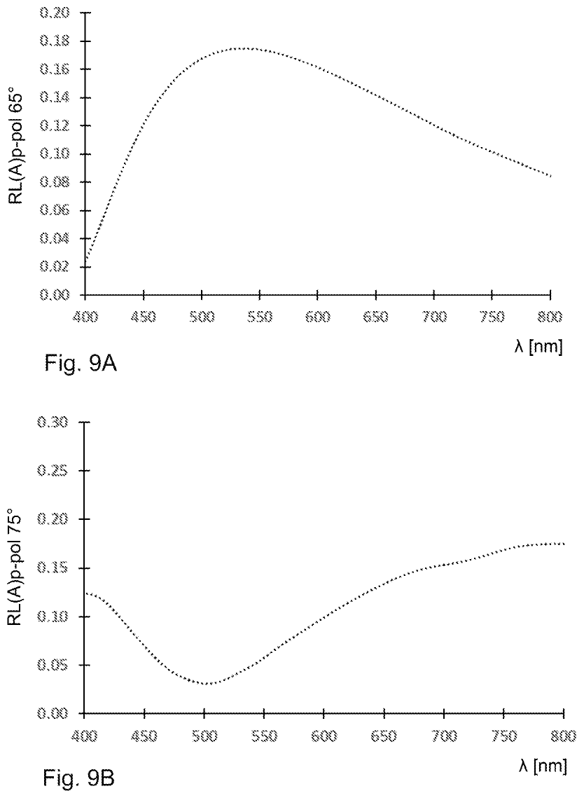

FIG. 9a shows a reflection spectrum of an inventive laminated pane according to Example 3 from Table 1 with respect to p-polarized radiation at 65°,

FIG. 9b shows a reflection spectrum of an inventive laminated pane according to Example 3 from Table 1 with respect to p-polarized radiation at 75°,

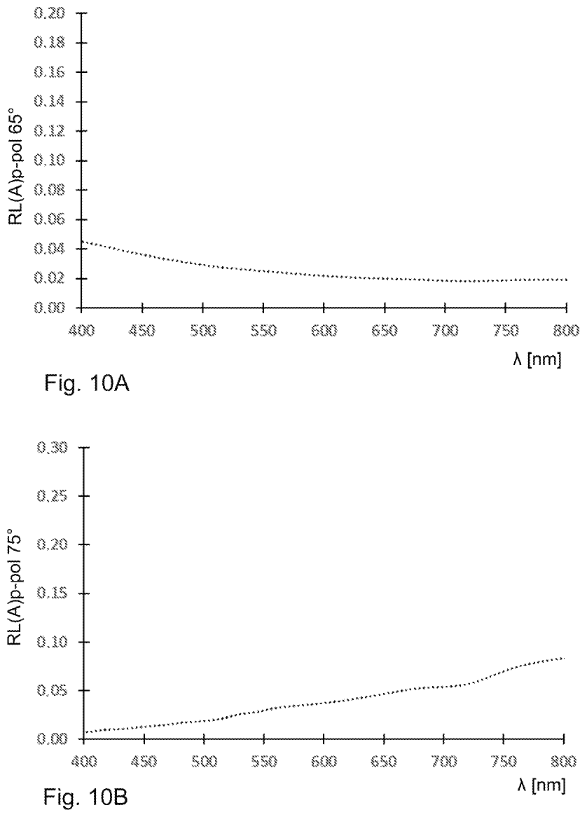

FIG. 10a shows a reflection spectrum of a non-inventive laminated pane according to comparative example 4 from Table 1 with respect to p-polarized radiation at 65°,

FIG. 10b shows a reflection spectrum of a non-inventive laminated pane according to comparative example 4 from Table 1 with respect to p-polarized radiation at 75°.

FIG. 1 shows a cross-sectional view of an exemplary embodiment of the projection arrangement 100 according to the invention in the installed state in a vehicle in a highly simplified, schematic representation. A plan view of the laminated pane 10 of the projection arrangement 100 is shown in FIG. 2. The cross-sectional view of FIG. 1 corresponds to the section line A-A of the laminated pane 1, as indicated in FIG. 2.

The laminated pane 10 comprises an outer pane 1 and an inner pane 2 with a thermoplastic intermediate layer 3 that is arranged between the panes. The laminated pane 10 is installed in a vehicle and separates a vehicle interior 12 from an external environment 13. The laminated pane 10 is, for example, the windshield of a motor vehicle.

The outer pane 1 and the inner pane 2 each consist of glass—preferably thermally pre-stressed soda-lime glass—and are transparent to visible light. The thermoplastic intermediate layer 3 comprises a thermoplastic, preferably polyvinyl butyral (PVB), ethylene vinyl acetate (EVA), and/or polyethylene terephthalate (PET).

The outer-side surface I of the outer pane 1 faces away from the thermoplastic intermediate layer 3 and is, at the same time, the outer surface of the laminated pane 10. The interior-side surface II of the outer pane 1 and the outer-side surface III of the inner pane 2 each face the intermediate layer 3. The interior-side surface IV of the inner pane 2 faces away from the thermoplastic intermediate layer 3 and is, at the same time, the inner side of the laminated pane 10. It is understood that the laminated pane 10 can have any suitable geometric shape and/or curvature. As a laminated pane 10, it typically has a convex curvature.

A frame-like circumferential opaque cover layer 5 is located on the interior-side surface II of the outer pane 1 in a circumferential edge region R of the laminated pane 10. The cover layer 5 is opaque and prevents the view to structures arranged on the inside of the laminated pane 10. Furthermore, in the edge region R on the interior-side surface IV of the inner pane 2, the laminated pane 1 also has an opaque cover layer 5 which is circumferential like a frame. The opaque cover layers 5 consist of an electrically non-conductive material conventionally used for cover prints, for example of a black-colored screen printing ink which is burnt in. The opaque cover layers 5 prevent the view through the laminated pane 10, as a result of which, for example, an adhesive strand for adhesively bonding the laminated pane 10 into a vehicle body is not visible from the outer side 13. At least one of the cover layers 5 is applied in a sub-region B of the pane. According to FIG. 2, a sub-region B extends circumferentially in the edge region R of the laminated pane 10. The sub-region B and the opaque cover layer 5 located therein are widened along an edge section of the laminated pane 10, wherein the widened sub-region B lies as a windshield in a motor vehicle adjacent to the engine edge and to the dashboard when the pane is in an installed state.

A reflective layer 9 is located on the opaque cover layer 5 applied on the interior-side surface IV of the inner pane 2. The reflective layer 9 is arranged in overlap with the underlying opaque cover layer 5 when viewed through the laminated pane 10, wherein said opaque cover layer 5 completely covers the reflective layer 9, i.e., the reflective layer 9 has no portion that is not in overlap with the underlying cover layer 5. The reflective layer 9 in this case is arranged, for example, only in a section of the edge region R of the laminated pane 10, which in the installed state is adjacent to the engine compartment of the motor vehicle. However, it would also be possible to arrange the reflective layer 9 in an upper (roof-side) section or in a lateral section of the edge region R. Furthermore, several reflective layers 9 could be provided in the mentioned sections of the edge region R. For example, the reflective layers 9 could be arranged such that a (partially) circumferential image is generated. The opaque cover layer 5 located on the interior-side surface IV of the inner pane 2 is widened in the section in which the first sub-region D with reflective layer 9 is located. In this way, an overlap is achieved of the first sub-region D with reflective layer 9 and the second sub-region B with opaque cover layer 5. “Width” is understood to mean the dimension of the opaque cover layer 5 perpendicular to its extension. The overlap according to the invention between reflective layer 9 and opaque cover layer 5 does not have to result from a cover layer 5 directly adjoining the reflective layer 9. In this sense, one of the opaque cover layers 5 according to FIG. 1 is only optional, wherein the remaining opaque cover layer 5 must fill a sub-region B which is at least partially congruent with the sub-region D of the reflective layer 9.

The projection arrangement 100 has a light source 8 as the image generator. The light source 8 is used to generate p-polarized light 7 (image information), which is directed onto the reflective layer 9 and is reflected by the reflective layer 9 as reflected light into the vehicle interior 12 where it can be perceived by a viewer, e.g., a driver. The reflective layer 9 is suitably designed to reflect the p-polarized light 7 of the light source 8, i.e., an image formed by the light 7 of the light source 8. The p-polarized light 7 preferably impinges on the laminated pane 1 at an angle of incidence of 50° to 80°, in particular of 65° to 75°. The light source 8 is, for example, a display, in the present case an LCD display. It would also be possible, for example, for the laminated pane 10 to be a roof panel, side pane, or rear pane.

In the plan view of FIG. 2, the reflective layer 9 is shown in extension along the lower section of the edge region R of the laminated pane 10.

Reference is now made to FIGS. 3 to 5 in which enlarged cross-sectional views of various embodiments of the laminated pane 1 are shown. The cross-sectional views of FIGS. 3 to 5 correspond to section line A-A in the lower section Z of the edge region R of the laminated pane 1, as indicated in FIG. 2.

The exemplary embodiment of the laminated pane 10 shown in FIG. 3 corresponds substantially to the laminated pane according to embodiment of FIG. 1. In addition, the laminated pane 10 comprises an HUD layer 4 which is applied on the interior-side surface II of the outer pane 1. The HUD layer 4 also extends into the see-through region of the laminated pane 10, i.e., the region in which none of the opaque cover layers 5 are present. A projector (not shown) can be directed onto this region of the pane, and the HUD layer 4 can be generated as a projection surface for a virtual image. In sub-region B, the opaque cover layer 5 is located on the interior-side surface IV of the inner pane 2 and covers the HUD layer 4 for the viewer located in the interior 12. In sub-region D, the reflective layer 9 is applied on the opaque cover layer 5 on the interior-side surface IV. The reflective layer 9 is applied directly to this opaque cover layer 5. The image projected onto the reflective layer 9 by the light source 8 can be clearly seen against the background of the opaque cover layer 5 with high contrast. The HUD layer 4 can be used independently of the reflective layer 9, wherein the image of the reflective layer 9 and the HUD image do not influence one another.

The embodiment of the laminated pane 10 shown in FIG. 4 differs from the embodiment of FIG. 3 only in that the reflective layer 9 is applied directly to the interior-side surface IV of the laminated pane 10. The opaque cover layer 5 closest to the reflective layer 9 is applied on the outer-side surface III of the inner pane 1 and serves there as an opaque background of the image of the reflective layer.

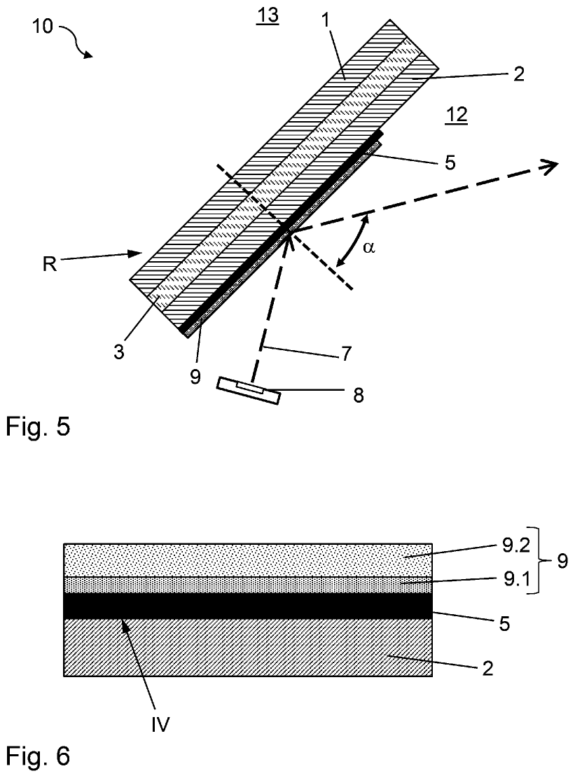

FIG. 5 shows another embodiment of the laminated pane 10 which substantially corresponds to the embodiment of FIG. 3, wherein in contrast thereto, only one single opaque cover layer 5 applied on the interior-side surface IV of the inner pane 2 is provided.

FIG. 6 shows a detailed view of the inner pane 2 with the reflective layer 9 of FIG. 1. The reflective layer 9 consists of two layers, a low refractive index layer 9.1 and a high refractive index layer 9.2, and is applied on the opaque cover layer 5.

In all exemplary embodiments, the reflective layer 9 is arranged on the vehicle interior side of the opaque cover layer 5, i.e., the reflective layer 9 is located in front of the opaque cover layer 5 when looking toward the inside of the laminated pane 1.

The invention is explained below with reference to examples and a comparative example. The reflection properties of inventive laminated panes for p-polarized light and a non-inventive laminated pane are compared below. The basic structure of the laminated panes corresponds to that described in FIG. 3, wherein the laminated panes differ in terms of the composition of the reflective layer. The reflective layer is applied in each case to the opaque cover layer 5 on the interior-side surface IV of the inner pane 2. The layer thicknesses, the layer structure and the refractive indices according to inventive examples 1 to 3 and non-inventive comparative example 4 are summarized in Table 1. All low refractive index layers and high refractive index layers were designed as sol-gel coatings.

TABLE 1

| | | | Layer thicknesses and refractive indices | | | |
|---|---|---|---|---|---|---|
| | Reference | | | | | Comparative |
| Material | signs | | Example 1 | Example 2 | Example 3 | Example 4 |
| TiO₂ | 9 | 9.1 | — | — | 50.0 nm, | — |
| | | | | | n = 2.30 | |
| SiO₂ | | 9.2 | 190.0 nm, | 190.0 nm, | 190.0 nm, | — |
| | | | n = 1.3 | n = 1.5 | n = 1.3 | |
| TiO₂ | | 9.1 | 50.0 nm, | 50.0 nm, | 50.0 nm, | 50.0 nm, |
| | | | n = 2.30 | n = 2.30 | n = 2.30 | n = 2.30 |
| Opaque | 5 | | | | | |
| screen | | | | | | |
| printing | | | | | | |
| Soda-lime | 2 | | | | | |
| glass | | | | | | |

The reflectivity for p-polarized light essential for image quality is identified by RL(A) p-pole and determined at the interior-side surface IV of the inner pane 2 at 65° and at 75°. The values for reflection (RL) relate to light type A, which by definition is based on the relative radiation distribution of the Planckian radiator with 2856 Kelvin. The corresponding reflection spectra are shown in FIGS. 7a, 7b, 8a, 8b, 9a, 9b, 10a, and 10b.

A comparison of the properties of the reflective layer 9 according to Examples 1 to 3 and Comparative Example 4 shows that the reflective layers according to the invention according to Examples 1 to 3 have a significantly increased reflection both at 65° and at 75° compared to Comparative Example 4. The laminated pane of inventive Example 3 shows a sufficiently high reflectivity at 65°. The laminated panes of Examples 1 and 2 were further optimized for use in a larger angular range. Reflective layers comprising exactly one low refractive index layer and one high refractive index layer have proven to be advantageous in this respect for achieving a lower angle dependence of the reflection properties. In comparison with the other examples and the Comparative Example, Example 1 has a low refractive index layer with a further reduced refractive index. The low refractive index layer according to Example 1 is designed as a nanoporous silicon oxide. The laminated pane according to Example 1 has proven to be advantageous as regards a particularly homogeneous reflection spectrum.
10 Laminated pane
1 Outer pane
2 Inner pane
3 Thermoplastic intermediate layer
4 HUD layer
5 Opaque cover layer
7 p-polarized light of the light source
8 Light source
9 Reflective layer
9.1 Optically high refractive index layer
9.2 Optically low refractive index layer
10 Laminated pane
12 Vehicle interior
13 External environment
100 Projection arrangement
D First sub-region
B Second sub-region
R Edge region
Outer side of the outer pane 1
II Inner side of the outer pane 1
E Outer side of the inner pane 2
IV Inner side of the inner pane 2
A-A′ Section line

1. A laminated pane (10) comprising an outer pane having an outer-side surface and an interior-side surface, an inner pane having an outer-side surface and an interior-side surface, and a thermoplastic intermediate layer, wherein
the interior-side surface of the outer pane and the outer-side surface of the inner pane are connected to one another via the thermoplastic intermediate layer,
a reflective layer is arranged in at least a first sub-region of the laminated pane on the interior-side surface of the inner pane directly adjacent to the surroundings, which reflective layer is configured to reflect p-polarized light of a light source,
at least one opaque cover layer is arranged at least in a second sub-region of the laminated pane on the outer-side surface of the outer pane, on the interior-side surface of the outer pane, on the outer-side surface of the inner pane, and/or on the interior-side surface of the inner pane, and a projection of the second sub-region into the plane of the first sub-region is at least partially congruent therewith, and wherein
in this order, starting from the interior-side surface, the reflective layer comprises at least one optically high refractive index layer with a refractive index of greater than or equal to 1.7 and an optically low refractive index layer with a refractive index of less than or equal to 1.6, arranged flat one above the other.

2. The laminated pane according to claim 1, wherein the reflective layer reflects at least 5% of the p-polarized light impinging on the reflective layer in a wavelength range of 450 nm to 650 nm.

3. (canceled)

4. The laminated pane according to claim 1, wherein at least one opaque cover layer is arranged at least partially in a circumferential edge region of the laminated pane.

5. The laminated pane according to claim 1, wherein at least one opaque cover layer in the form of an opaque cover print is arranged on the interior-side surface of the outer pane and/or the interior-side surface of the inner pane.

6. The laminated pane according to claim 1, wherein the refractive index of the optically high refractive index layer is at least 1.8.

7. The laminated pane according to claim 1, wherein the optically high refractive index layer contains silicon nitride, a silicon-metal mixed nitride, aluminum nitride, tin oxide, niobium oxide, bismuth oxide, titanium oxide, tin-zinc mixed oxide, zirconium oxide, scandium oxide, yttrium oxide, tantalum oxide, lanthanum oxide or cerium oxide.

8. The laminated pane according to claim 1, wherein the refractive index of the optically low refractive index layer is at most 1.6.

9. The laminated pane according to claim 1, wherein the optically low refractive index layer contains silicon oxide.

10. The laminated pane according to claim 1, wherein the optically low refractive index layer is a sol-gel coating in which closed and/or open nanopores are formed.

11. The laminated pane according to claim 10, wherein the low refractive index layer has pores with a size of 1 nm to 500 nm.

12. The laminated pane according to claim 1, wherein the reflective coating comprises exactly one high refractive index layer and exactly one low refractive index layer.

13. The laminated pane according to claim 1, wherein an HUD reflective layer is arranged between the interior-side surface of the outer pane and the interior-side surface of the inner pane.

14. A method for producing a projection arrangement according to claim 16, comprising:
a) providing an outer pane, an inner pane and a thermoplastic intermediate layer,
b) applying at least one opaque cover layer is applied on at least a second sub-region of the outer-side surface of the outer pane, the interior-side surface of the outer pane, the outer-side surface of the inner pane and/or to the outer-side surface of the inner pane,
c) assembling at least the inner pane, the thermoplastic intermediate layer, and the outer pane in this order to form a layer stack,
d) laminating the layer stack consisting of at least inner pane, thermoplastic intermediate layer and outer pane is laminated to form a laminated pane,
e) applying a reflective layer is applied on at least a first sub-region of the interior-side surface of the inner pane, and
f) orienting a light source for p-polarized light relative to the laminated pane such that the p-polarized light of the light source falls onto the reflective layer,
wherein step e) can take place before, during or after steps a) to d) but, if there is an opaque cover layer on the outer-side surface of the inner pane, step e) takes place after the application of said opaque cover layer.

15. A method comprising providing a projection arrangement according to claim 16 in vehicles for traffic on land, in the air, or on water.

16. A projection arrangement comprising a light source for p-polarized light and a laminated pane according to claim 1, wherein
the reflective layer is configured to reflect the p-polarized light of the light source, and
the interior-side surface of the inner pane is the surface of the laminated pane closest to the light source for p-polarized light.

17. The projection arrangement according to claim 16, wherein the light source for p-polarized light is a display.

18. The laminated pane according to claim 2, wherein the reflective layer reflects at least 10% of the p-polarized light impinging on the reflective layer in a wavelength range of 450 nm to 650 nm.

19. The laminated pane according to claim 6, wherein the refractive index of the optically high refractive index layer is at least 2.0.

20. The laminated pane according to claim 7, wherein the optically high refractive index layer contains titanium oxide.

21. The laminated pane according to claim 8, wherein the refractive index of the optically low refractive index layer is at most 1.4.
